(19) United States
(12) Patent Application Publication
(10) Pub. No.: US 2021/0188081 A1
(43) Pub. Date: Jun. 24, 2021

(54) RESIN FILLER TUBE AND MANUFACTURING METHOD FOR THE SAME

(71) Applicant: Sumitomo Riko Company Limited, Komaki-shi (JP)

(72) Inventors: Fumiya MIZUNO, Komaki-shi (JP); Tomoyuki FUKUYASU, Komaki-shi (JP); Atsuo MIYAJIMA, Komaki-shi (JP)

(73) Assignee: Sumitomo Riko Company Limited, Komaki-shi (JP)

(21) Appl. No.: 17/130,081

(22) Filed: Dec. 22, 2020

(30) Foreign Application Priority Data
Dec. 23, 2019 (JP) 2019-231090

(51) Int. Cl. B60K 15/04; B29C 48/00; B29C 48/09; B29C 48/15

(52) U.S. Cl. CPC B60K 15/04; B29C 48/0021; B60K 2015/0346; B29C 48/15; B29C 48/09

(57) ABSTRACT

A resin filler tube includes: a tubular body; a flange that protrudes radially outward from an end of the tubular body on a fuel tank side, over an entire circumference, has a plurality of layers that are of same kinds as those of the tubular body, has outer faces all of which are formed of an outermost layer material, and has a first end face, in an axial direction, forming a weld surface to be welded to an outer circumferential edge of an opening hole of the fuel tank; and a leading end tubular portion extending from a radially inner portion of the flange toward a leading end of the filler tube, and having an annular recessed groove formed at a portion of an outer circumferential surface on the flange side, over an entire circumference, for storing a melt burr generated in welding of the first end face.

### CROSS REFERENCE TO RELATED APPLICATIONS

This application claims priority based on Japanese Patent Application No. 2019-231090 filed on Dec. 23, 2019, the entire contents of which are incorporated by reference herein.

### 1. TECHNICAL FIELD

The present invention relates to a resin filler tube and a manufacturing method for the resin filler tube.

### 2. BACKGROUND ART

WO2010015295A1 discloses that an outer circumferential edge of an opening hole of a fuel tank and a flange of a filler tube are fixed to each other by a clamp ring. An O-ring for sealing is disposed between an inner circumferential surface of the opening hole of the fuel tank and an outer circumferential surface of the filler tube.

JP2018-118498A discloses that an outer circumferential edge of an opening hole of a resin fuel tank and an axial end face of a flange of a resin filler tube are joined to each other by welding. The outer face of the resin filler tube has an outermost layer formed by an outermost layer material over the entire length. The outermost layer of the flange is welded to the fuel tank. Furthermore, a material having preferable weldability is used as the outermost layer material, whereby performance such as a welding strength of a weld surface is enhanced.

JP2007-8352A discloses that an outer circumferential edge of an opening hole of a fuel tank and a flange of a filler tube are welded to each other. An outer layer material and an inner layer material of the flange of the filler tube are exposed at a weld surface, and the outer layer material protrudes as compared with the inner layer material such that melted resin of the inner layer material does not hinder welding between the outer layer material and the fuel tank. Furthermore, a recessed groove is formed in the end face of the flange. Therefore, even if the inner layer material is melted, the melted inner layer material flows into the recessed groove, thereby inhibiting the melted inner layer material from flowing into the weld surface between the outer layer material and the fuel tank.

JP2018-69786A, JP2019-156011A, and JP2003-194380A also disclose that an outer circumferential edge of an opening hole of a fuel tank and an axial end face of a flange of a filler tube are joined to each other by welding.

### SUMMARY

In a case where the outer circumferential edge of the opening hole of the fuel tank and the axial end face of the flange of the resin filler tube are joined to each other by welding, melt burrs are generated around the weld surface by the welding. That is, the melt burrs are generated so as to protrude from the weld surface toward the outer circumferential side and also protrude from the weld surface toward the inner circumferential side.

A small gap is formed in the radial direction between the inner circumferential surface of the opening hole of the fuel tank and the leading end tubular portion of the resin filler tube. If the gap in the radial direction is increased, accuracy for positioning the resin filler tube and the fuel tank is affected. Therefore, increase of the gap in the radial direction is not preferable. Accordingly, a sufficient portion into which the melt burrs on the inner circumferential side escape is not assured, so that the melt burrs are likely to affect stability of the weld surface.

An object of the present invention is to provide a resin filler tube that prevents melt burrs from affecting stability of a weld surface and allows stability of the weld surface to be enhanced, and a manufacturing method for manufacturing the resin filler tube.

(1. Resin Filler Tube)

A resin filler tube is directed to a resin filler tube to be welded to an outer circumferential edge of an opening hole of a fuel tank. The resin filler tube includes: a tubular body having an outermost layer formed by using an outermost layer material, and one or more inner layers each formed by using an inner layer material; a flange configured to protrude radially outward from an end of the tubular body on the fuel tank side, over an entire circumference, the flange having a plurality of layers that are of same kinds as those of the tubular body, the flange having outer faces all of which are formed of the outermost layer material, the flange having a first end face in an axial direction, the first end face forming a weld surface to be welded to the outer circumferential edge of the opening hole of the fuel tank; and a leading end tubular portion extending from a radially inner portion of the flange toward a leading end of the resin filler tube, the leading end tubular portion having an annular recessed groove formed at a portion of an outer circumferential surface on the flange side, over an entire circumference, the annular recessed groove storing a melt burr generated in welding of the first end face.

In the resin filler tube, the leading end tubular portion has the annular recessed groove. Therefore, a part of melt burrs on the inner circumferential side is stored in the annular recessed groove. Thus, the annular recessed groove assuredly forms a portion into which the melt burrs escape, so that stability of a weld surface is enhanced without the melt burrs influencing the stability of the weld surface.

(2. Manufacturing Method for Resin Filler Tube)

A manufacturing method for manufacturing the resin filler tube includes: extruding a tubular material having a plurality of layers by an extruder; and forming the resin filler tube by bringing the tubular material into close contact with an inner face formed by a plurality of split molds while sequentially moving the plurality of split molds in a direction in which the tubular material is extruded, such that the resin filler tube has an outer face corresponding to the inner face.

The resin filler tube described above is manufactured by the manufacturing method. A part of melt burrs on the inner circumferential side is stored in the annular recessed groove when the resin filler tube is welded to the fuel tank. Accordingly, the annular recessed groove exhibits the above-described effect.

### BRIEF DESCRIPTION OF DRAWINGS

FIG. 1 illustrates a fuel line;

FIG. 2 is an axial cross-sectional view of a filler tube shown in FIG. 1 in a linearly extending state;

FIG. 3 is an enlarged cross-sectional view of a portion III in FIG. 2, illustrating a state where a flange of the filler tube is in contact with an outer circumferential edge of an opening hole of a fuel tank, and both of the flange and the outer circumferential edge of the opening hole of the fuel tank have not been welded yet, and indicating that a contour at a to-be-welded portion represents non-deformed shapes of the filler tube and the fuel tank which have not been welded yet;

FIG. 4 is an enlarged cross-sectional view of the portion III in FIG. 2, illustrating a state where the flange of the filler tube has been welded to the outer circumferential edge of the opening hole of the fuel tank, and indicating that a solid line at the welded portion represents shapes of the filler tube and the fuel tank which have been deformed by welding and an alternate long and two short dashes line at the welded portion represents non-deformed shapes of the filler tube and the fuel tank which have not been welded yet;

FIG. 5 is a flow chart showing a method for manufacturing a tank unit (fuel tank, filler tube, check valve);

FIG. 6 is a plan view of a manufacturing apparatus for manufacturing the filler tube;

FIG. 7 is a cross-sectional view taken along a line VII-VII in FIG. 6; and

FIG. 8 illustrates a gap between a nozzle of an extruder and an outer face of a second end portion (inner circumferential surfaces of split molds).

### DESCRIPTION OF EMBODIMENTS

(1. Structure of Fuel Line 1)

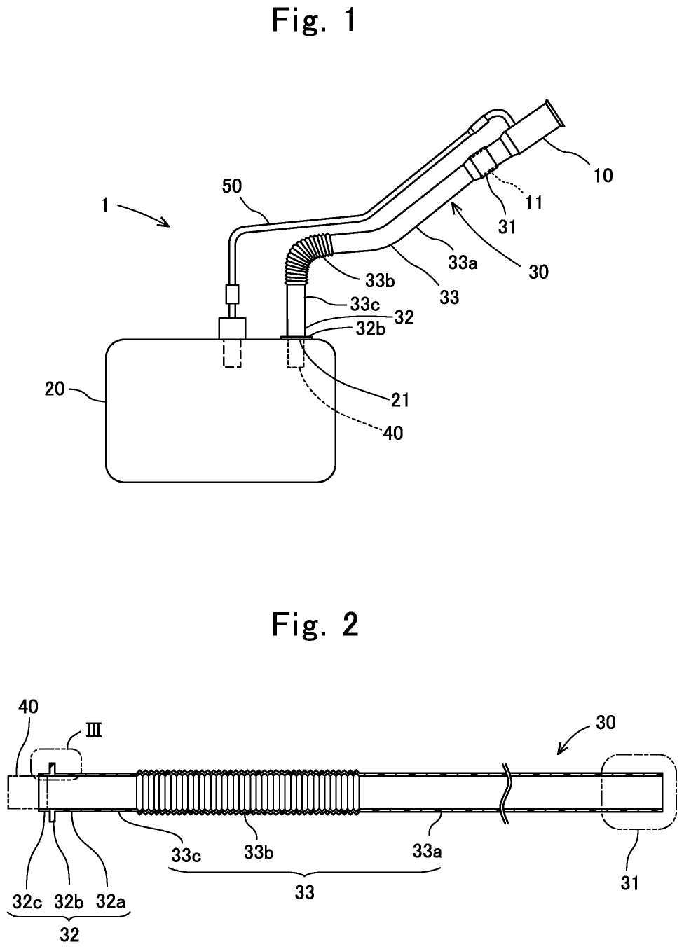

A structure of a fuel line 1 will be described with reference to FIG. 1. The fuel line 1 is a path extending from an oil filler port 10 through a fuel tank 20 to an internal combustion engine (not shown) in an automobile. In the present embodiment, a portion of the fuel line 1 from the oil filler port 10 to the fuel tank 20 will be described.

The fuel line 1 includes at least the oil filler port 10, the fuel tank 20, a resin filler tube 30, and a check valve 40. In the present embodiment, the fuel line 1 further includes a breather line 50.

The oil filler port 10 is disposed near the outer face of an automobile, and allows an oil supply nozzle (not shown) to be inserted therein. The oil filler port 10 is made of resin or metal. The oil filler port 10 is either an oil filler port having an oil filler cap attached thereto, or a capless oil filler port which does not have an oil filler cap attached thereto.

The fuel tank 20 is molded by using thermoplastic resin, and stores liquid fuel such as gasoline. The fuel tank 20 includes, for example, a plurality of kinds of resin layers. The liquid fuel stored in the fuel tank 20 is fed to the not-illustrated internal combustion engine, and is used for driving the internal combustion engine. The fuel tank 20 has an opening hole 21 for feeding fuel. The opening hole 21 for feeding fuel is formed in, for example, the upper face or the side face of the fuel tank 20.

The filler tube 30 is molded by using thermoplastic resin, and connects between the oil filler port 10 and the fuel tank 20. The filler tube 30 has one or more bent portions for routing, in general. The filler tube 30 is formed by one member or is formed by a plurality of members joined to each other. In the present embodiment, an example in which the filler tube 30 is integrally formed by one member over the entire length, will be described.

A first end portion 31 of the filler tube 30 is press-fitted to a tubular portion 11 of the oil filler port 10. A second end portion 32 of the filler tube 30 is welded to the outer circumferential edge of the opening hole 21 in the outer face of the fuel tank 20. In the present embodiment, a part of the second end portion 32 is inserted in the opening hole 21 of the fuel tank 20.

The oil supply nozzle is inserted in the oil filler port 10 and liquid fuel is fed through the oil supply nozzle, whereby the liquid fuel passes through the filler tube 30 and is stored in the fuel tank 20. In a case where the fuel tank 20 has been filled with liquid fuel, liquid fuel is stored in the filler tube 30, and the liquid fuel comes into contact with the tip of the oil supply nozzle to automatically stop feeding liquid fuel through the oil supply nozzle.

The check valve 40 is disposed near the opening hole 21 of the fuel tank 20. The check valve 40 is fixed to the second end portion 32 of the filler tube 30, or fixed between the filler tube 30 and the opening hole 21 of the fuel tank 20. When liquid fuel is fed from the filler tube 30 into the fuel tank 20, the liquid fuel passes through the check valve 40. In this case, in a case where liquid fuel is fed from the filler tube 30 into the fuel tank 20, backflow of the liquid fuel in the fuel tank 20 toward the filler tube 30 is prevented.

The breather line 50 connects between the oil filler port 10 and the fuel tank 20, and is disposed parallel to the filler tube 30. The breather line 50 is a line for discharging fuel vapor in the fuel tank 20 to the outside of the fuel tank 20 when liquid fuel is fed through the filler tube 30 into the fuel tank 20.

(2. Schematic Structure of Filler Tube 30)

The schematic structure of the filler tube 30 will be described with reference to FIG. 2. The filler tube 30 is structured to have a plurality of layers made of different kinds of thermoplastic resins. As shown in FIG. 2, the filler tube 30 includes the first end portion 31 formed at one end portion in the tube axis direction, the second end portion 32 formed at the other end portion in the tube axis direction, and an intermediate portion 33 connecting between the first end portion 31 and the second end portion 32.

The first end portion 31 is formed in a cylindrical shape, and fitted to the outer face of the tubular portion 11 of the oil filler port 10. The first end portion 31 is formed so as to be deformed more easily than the tubular portion 11 of the oil filler port 10. Therefore, the first end portion 31 is fitted to the tubular portion 11 of the oil filler port 10 in a state where the first end portion 31 is deformed to increase the diameter.

The second end portion 32 is formed in a tubular shape, and is welded to the outer circumferential edge of the opening hole 21 of the fuel tank 20. The second end portion 32 includes a flange 32b that protrudes radially outward from a tubular body 32a over the entire circumference. The flange 32b is welded to the fuel tank 20. That is, the flange 32b of the second end portion 32 functions so as to assure a sufficient weld area for welding to the fuel tank 20. The second end portion 32 further includes a leading end tubular portion 32c extending to be closer to the leading end side of the filler tube 30 than the flange 32b. Apart of the leading end tubular portion 32c is inserted in the opening hole 21 of the fuel tank 20. The check valve 40 is attached to the inner circumferential surface of the leading end tubular portion 32c.

The intermediate portion 33 is designed as appropriate so as to form a path according to relative positions of the oil filler port 10 and the fuel tank 20 and a distance therebetween, a layout of peripheral devices, and the like. In the present embodiment, the intermediate portion 33 includes a first tubular portion 33a that does not have a bellows-like shape, a bellows portion 33b, and a second tubular portion 33c that does not have a bellows-like shape. The first tubular portion 33a is connected to the first end portion 31, and is previously bent in a mid-portion in the tube axis direction. The bellows portion 33b is connected to the first tubular portion 33a, and formed in a bellows-like tubular shape so as to be bendable as appropriate. The second tubular portion 33c is connected to the bellows portion 33b, and is also connected to the second end portion 32. The second tubular portion 33c is substantially formed in a cylindrical shape.

In an example other than the above-described example, the intermediate portion 33 of the filler tube 30 includes, for example, a plurality of the bellows portions, the entirety of the intermediate portion 33 is formed of the bellows portion, or the intermediate portion 33 includes no bellows portions. The first tubular portion 33a does not have a bellows-like shape and is bent. However, in another example, the first tubular portion 33a linearly extends.

(3. Layer Structure of Filler Tube 30)

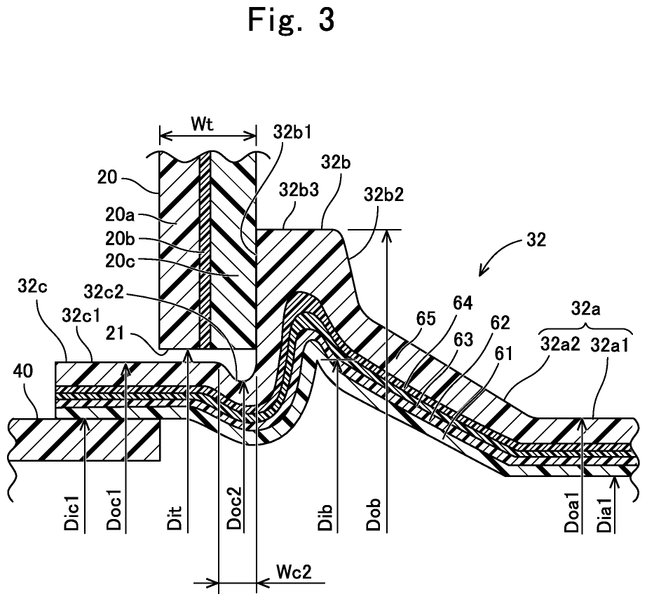

A layer structure of the filler tube 30 will be described with reference to FIG. 3. FIG. 3 is an enlarged cross-sectional view of a portion III in FIG. 2, and is an axial cross-sectional view of the second end portion 32 of the filler tube 30. The filler tube 30 has a uniform layer structure over the entire length. Therefore, portions other than the second end portion 32 of the filler tube 30 have the same layer structure. That is, in the filler tube 30, all of the first end portion 31, the second end portion 32, and the intermediate portion 33 have the same layer structure.

As shown in FIG. 3, the filler tube 30 is structured to have a plurality of layers made of different kinds of thermoplastic resins. The filler tube 30 includes, for example, an innermost layer 61, an inner adhesive layer 62, an intermediate layer 63, an outer adhesive layer 64, and an outermost layer 65 in order, respectively, from the inner layer side. The filler tube 30 is structured to have the plurality of layers over the entire length. The structure of the filler tube 30 is not limited to the five layer structure. In another example, the number of the layers of the filler tube 30 is not greater than four or not less than six.

The layers 61 to 64 other than the outermost layer 65 are collectively referred to as inner layers. The inner layers 61 to 64 are formed of inner layer materials. The outermost layer 65 is formed of an outermost layer material. The number of the inner layers 61 to 64 is not less than one. In the present embodiment, the filler tube 30 includes the four inner layers 61 to 64. Each layer will be described below.

The innermost layer 61 comes into contact with liquid fuel (gasoline), and a gasoline-resistant material is thus used as the innermost layer material (one of the inner layer materials) of the innermost layer 61. The innermost layer 61 preferably has a catching force (disengagement preventing force) for catching the tubular portion 11 of the oil filler port 10 in the axial direction in a state where the first end portion 31 is press-fitted to the tubular portion 11 of the oil filler port 10. In this case, a material having sealability is used as the innermost layer material of the innermost layer 61. The innermost layer material of the innermost layer 61 essentially contains, for example, high density polyethylene (HDPE). However, another material is allowed to be used for the innermost layer 61 as long as the material exhibits the above-described performance.

The intermediate layer 63 is disposed on the outer circumference side of the innermost layer 6l. The intermediate layer material (one of the inner layer materials) of the intermediate layer is, for example, resistant to fuel permeation. For the intermediate layer 63, for example, a material that essentially contains either ethylene-vinyl alcohol copolymer (EVOH) or polyamide (PA) is preferably used as the intermediate layer material resistant to fuel permeation. However, another material is allowed to be used for the intermediate layer 63 as long as the material exhibits the above-described performance.

The outermost layer 65 is disposed on the outer circumference side of the intermediate layer 63. The outermost layer 65 protects the intermediate layer 63. The outermost layer 65 forms the outermost surface of the filler tube 30. Therefore, for example, a material having impact resistance, weather resistance, and chemical resistance is preferably used as the outermost layer material of the outermost layer 65. In this case, for the outermost layer 65, a material that essentially contains either high density polyethylene (HDPE) or polyamide (PA) is used as the outermost layer material.

Furthermore, in the present embodiment, the outermost layer 65 forms a layer to be welded to the fuel tank 20. Therefore, a material having preferable weldability with respect to a material of the outer face of the fuel tank 20 is preferably used for the outermost layer material of the outermost layer 65. Particularly, the outermost layer material of the outermost layer 65 and the material of the outer face of the fuel tank 20 are preferably of the same kind. However, another material is allowed to be used for the outermost layer 65 as long as the material exhibits the above-described performance.

The inner adhesive layer 62 is a layer for adhering the outer circumferential surface of the innermost layer 61 and the inner circumferential surface of the intermediate layer 63 to each other. The outer adhesive layer 64 is a layer for adhering the outer circumferential surface of the intermediate layer 63 and the inner circumferential surface of the outermost layer 65 to each other. For example, a material that essentially contains modified polyethylene (modified PE) is preferably used as the inner adhesive layer material (one of the inner layer materials) of the inner adhesive layer 62 and the outer adhesive layer material (one of the inner layer materials) of the outer adhesive layer 64. However, in a case where at least one of the innermost layer 61 and the intermediate layer 63 has adhesiveness to the other thereof, the inner adhesive layer 62 is unnecessary. In a case where at least one of the intermediate layer 63 and the outermost layer 65 has adhesiveness to the other thereof, the outer adhesive layer 64 is unnecessary.

(4. Layer Structure of Fuel Tank 20)

The layer structure of the fuel tank 20 will be described with reference to FIG. 3. FIG. 3 is a cross-sectional view of a portion near the opening hole 21 of the fuel tank 20. The fuel tank 20 is structured to have a plurality of layers made of different kinds of thermoplastic resins. The fuel tank 20 is structured to have, for example, five layers (innermost layer, inner adhesive layer, intermediate layer, outer adhesive layer, and outermost layer), similarly to the filler tube 30.

In FIG. 3, the fuel tank 20 has a three layer structure, that is, includes an innermost layer 20a, an intermediate layer 20b, and an outermost layer 20c. The innermost layer 20a, the intermediate layer 20b, and the outermost layer 20c are, for example, formed in manners similar to manners in which the innermost layer 61, the intermediate layer 63, and the outermost layer 65, respectively, of the filler tube 30 are formed. The structure of the fuel tank 20 is not limited to the three layer structure. In another example, the number of the layers of the fuel tank 20 is two or not less than four.

(5. Specific Structure of Second End Portion 32 of Filler Tube 30)

Next, the specific structure of the second end portion 32 of the filler tube 30 will be described with reference to FIG. 3. The second end portion 32 includes the tubular body 32a, the flange 32b, and a leading end tubular portion 32c.

The tubular body 32a is formed in a tubular shape, and forms a portion of the second end portion 32 on the first end portion 31 side and the intermediate portion 33 side. That is, one end (not shown, the end portion located rightward of the region in FIG. 3) of the tubular body 32a is connected to the intermediate portion 33 of the filler tube 30. The tubular body 32a is formed in a cylindrical shape having a constant diameter over the entire length, a tubular shape having a plurality of diameters, or a tubular shape having a reverse tapered portion.

The tubular body 32a is structured to have the plurality of layers (61 to 65) described above, from the inner face toward the outer face. The tubular body 32a has a minimum outer diameter portion 32a1 that is formed in a cylindrical shape and that has a predetermined smallest outer diameter Doa1 in the tubular body 32a. The minimum outer diameter portion 32a1 of the tubular body 32a has a minimum inner diameter Dia1.

In the present embodiment, the tubular body 32a has a reverse tapered portion 32a2 having a diameter increased from the end of the minimum outer diameter portion 32a1 in the axial direction. The reverse tapered portion 32a2 is closer to the leading end side (left side in FIG. 3) of the second end portion 32 than the minimum outer diameter portion 32a1 is. Both the outer face and the inner face of the reverse tapered portion 32a2 are formed in reverse taper. The tubular body 32a has a constant thickness over the entire length, or has various thicknesses. For example, the reverse tapered portion 32a2 has a thickness increased toward the leading end side of the second end portion 32.

The flange 32b protrudes radially outward from the end of the tubular body 32a on the fuel tank 20 side (the leading end side of the second end portion 32), over the entire circumference. The outer face of the flange 32b includes a first end face 32b1 in the axial direction, a second end face 32b2 located on the back side surface of the first end face, and an outer circumferential surface 32b3.

The first end face 32b1 forms a weld surface to be welded to the outer circumferential edge of the opening hole 21 of the fuel tank 20. The first end face 32b1 is formed in a flat surface that is substantially orthogonal to the center axis of the second end portion 32 of the filler tube 30. The second end face 32b2 is reversely tapered so as to be slightly tilted relative to the first end face 32b1. The outer circumferential surface 32b3 is substantially formed in a cylindrical shape.

The flange 32b is also structured to have the plurality of layers (61 to 65) that are of the same kinds as those of the tubular body 32a, from the inner face toward the outer face. Accordingly, the entirety of the outer face of the flange 32b is formed by the outermost layer material. That is, all of the first end face 32b1, the second end face 32b2, and the outer circumferential surface 32b3 that form the flange 32b are formed of the outermost layer material only. A melt portion at the first end face 32b1 by welding is formed of the outermost layer material only.

The outer circumferential surface 32b3 of the flange 32b has an outer diameter Dob. The flange 32b is filled over the entire range, in a radial range of the first end face 32b1 that is welded to the fuel tank 20. Accordingly, the flange 32b has a thickness greater than the tubular body 32a. In the present embodiment, a maximum inner diameter Dib of the flange 32b is less than an inner diameter Dit of the opening hole 21 of the fuel tank 20. However, the present invention is not limited thereto as long as most of the radial range in which the to-be-welded first end face 32b1 of the flange 32b is welded to the fuel tank 20, is filled. In this case, the maximum inner diameter Dib of the flange 32b is allowed to be slightly greater than the inner diameter Dit of the opening hole 21 of the fuel tank 20.

The leading end tubular portion 32c extends from a radially inner portion of the flange 32b to the leading end side of the filler tube 30 (the leading end side of the second end portion 32). The check valve 40 is attached to the inner circumferential surface of the leading end tubular portion 32c. The leading end tubular portion 32c is structured to have the plurality of layers (61 to 65) described above, from the inner face toward the outer face.

The leading end tubular portion 32c is formed so as to have an outer diameter that is less than the inner diameter Dit of the inner circumferential surface of the opening hole 21 of the fuel tank 20 over the entire length. That is, a gap is formed between the outer circumferential surface of the leading end tubular portion 32c and the inner circumferential surface of the opening hole 21 over the entire circumference.

The leading end tubular portion 32c has a maximum outer diameter portion 32c1 that is formed in a cylindrical shape, and that has a predetermined greatest outer diameter Doc1 in the leading end tubular portion 32c. The maximum outer diameter portion 32c1 of the leading end tubular portion 32c has a minimum inner diameter Dic1. The leading end tubular portion 32c is allowed to have another cylindrical portion or a tapered portion in a portion closer to the leading end than the maximum outer diameter portion 32c1 is.

The leading end tubular portion 32c has an annular recessed groove 32c2 formed on the flange 32b side of the outer circumferential surface over the entire circumference. The cross-section of the annular recessed groove 32c2 in the axial direction is shaped in a curved recess. The annular recessed groove 32c2 has a surface continuous with the first end face 32b1 without having a stepped portion between the annular recessed groove 32c2 and the first end face 32b1 of the flange 32b. The annular recessed groove 32c2 is formed so as to have a groove width Wc2 that is less than a thickness Wt of the inner circumferential surface of the opening hole 21 of the fuel tank 20. That is, the annular recessed groove 32c2 is located outward of the inner circumferential surface of the opening hole 21 of the fuel tank 20.

The maximum outer diameter Doc1 of the leading end tubular portion 32c is greater than the outer diameter Doa1 of the minimum outer diameter portion 32a1 of the tubular body 32a. A minimum outer diameter Doc2 of the annular recessed groove 32c2 of the leading end tubular portion 32c is less than the maximum outer diameter Doc1 of the leading end tubular portion 32c, and equal to or greater than the outer diameter Doa1 of the minimum outer diameter portion 32a1 of the tubular body 32a. In the present embodiment, the minimum outer diameter Doc2 of the annular recessed groove 32c2 of the leading end tubular portion 32c is greater than the outer diameter Doa1 of the minimum outer diameter portion 32a1 of the tubular body 32a.

(6. Welded State in which Flange 32b and Fuel Tank 20 are Welded to Each Other)

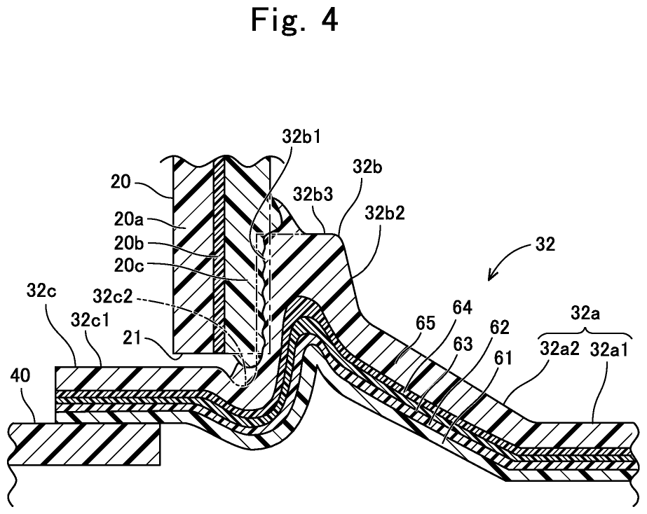

Next, a welded state in which the first end face 32b1 of the flange 32b and the outer circumferential edge of the opening hole 21 of the fuel tank 20 are welded to each other, will be described with reference to FIG. 4. As shown in FIG. 4, the first end face 32b1 and the outer circumferential edge of the opening hole 21 are melted and adhered to each other. At this time, melt burrs are generated in welding between the first end face 32b1 and the outer circumferential edge of the opening hole 21. The melt burrs protrude toward both the outer circumferential side of the weld surface and the inner circumferential side of the weld surface.

An outer region outside the outer circumferential surface 32b3 of the flange 32b is on the outer circumferential side of the weld surface, and thus has a sufficient space. Meanwhile, a radial gap region between the inner circumferential surface of the opening hole 21 of the fuel tank 20 and the outer circumferential surface of the leading end tubular portion 32c is on the inner circumferential side of the weld surface. The leading end tubular portion 32c has the annular recessed groove 32c2 formed therein. Accordingly, the annular recessed groove 32c2 stores the melt burrs generated in welding of the first end face 32b1 of the flange 32b.

Thus, since the leading end tubular portion 32c has the annular recessed groove 32c2, a part of the melt burrs on the inner circumferential side is stored in the annular recessed groove 32c2. Thus, the annular recessed groove 32c2 assuredly forms a portion into which the melt burrs escape. Therefore, stability of the weld surface is enhanced without the melt burrs influencing the stability of the weld surface.

(7. Method for Manufacturing Tank Unit (20, 30, 40))

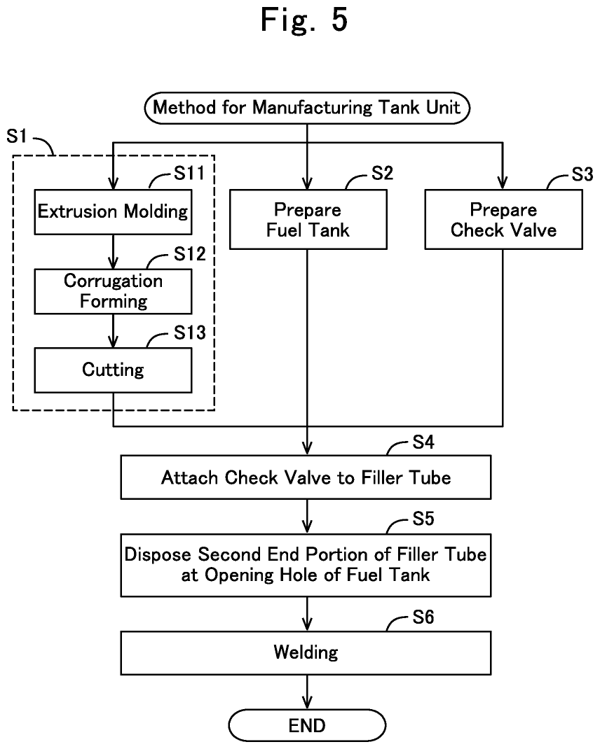

Next, a method for manufacturing the tank unit (20, 30, 40) that includes the fuel tank 20, the filler tube 30, and the check valve 40 will be described with reference to FIG. 5.

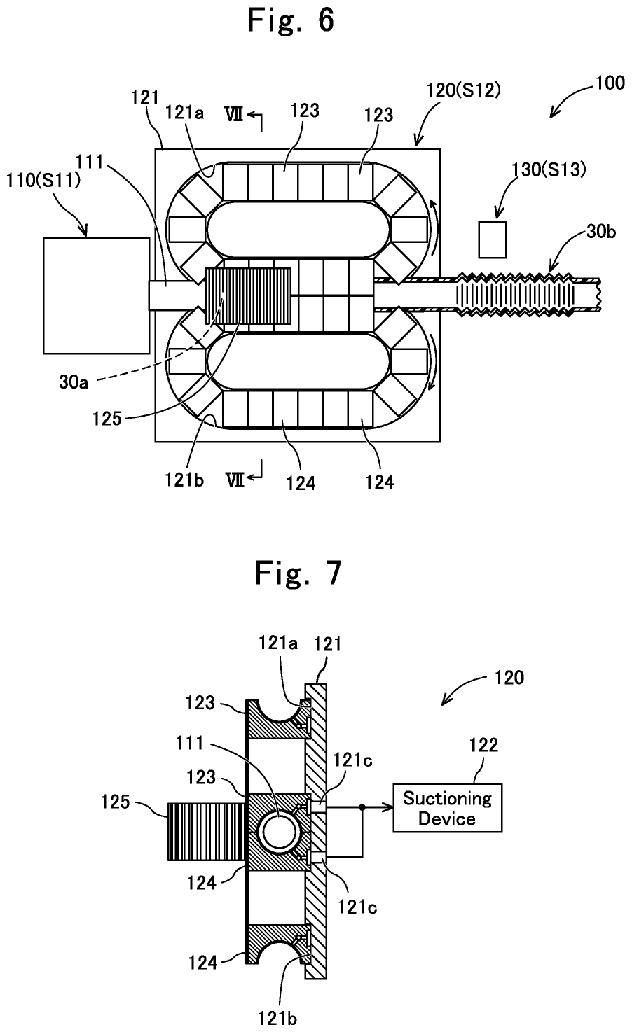

Firstly, the filler tube 30 is manufactured (S1: □filler tube manufacturing step□). The filler tube 30 is formed by extrusion molding. Accordingly, in the filler tube manufacturing step S1, a primary material 30a (shown in FIG. 6) is formed by extrusion molding (S11), and a secondary material 30b (shown in FIG. 6) is formed by corrugation forming (S12), and the secondary material 30b is finally cut, thereby forming the filler tube 30 (S13). The method for manufacturing the filler tube 30 will be described below in more detail.

The fuel tank 20 is prepared (manufactured) (S2: □fuel tank preparing step□). The check valve 40 is prepared (S3: □check valve preparing step□). Subsequently, the check valve 40 is attached to the second end portion 32 of the filler tube 30 (S4: □check valve attaching step□). Subsequently, the second end portion 32 of the filler tube 30 is disposed at the position (welding initial position) of the opening hole 21 of the fuel tank 20 (S5: □initial position disposition step□). Subsequently, the flange 32b of the second end portion 32 of the filler tube 30 and the outer circumferential edge of the opening hole 21 of the fuel tank 20 are welded to each other (S6: □welding step□). In a case where the check valve 40 is attached after the welding, step S4 is performed after step S6.

(8. Structure of Manufacturing Apparatus 100 for Filler Tube 30)

Next, the structure of a manufacturing apparatus 100 for manufacturing the filler tube 30 will be described with reference to FIG. 6 and FIG. 7. The filler tube 30 is manufactured by the manufacturing apparatus 100 shown in FIG. 6. The manufacturing apparatus 100 includes an extruder 110, a corrugation molding machine 120 arranged continuously with the extruder 110, and a cutting machine 130 arranged continuously with the corrugation molding machine 120.

That is, the tubular primary material 30a (tubular material) is formed by the extruder 110 (S11 in FIG. 5), the tubular secondary material 30b is formed by the corrugation molding machine 120 (S12 in FIG. 5), and the filler tube 30 is formed by the cutting machine 130 (S13 in FIG. 5).

The extruder 110 performs extrusion molding to form the tubular primary material 30a. The primary material 30a is structured to have a plurality of layers (61 to 65) as shown in FIG. 3, and is formed in a cylindrical shape having a constant inner diameter and a constant outer diameter in the axial direction. That is, the primary material 30a is formed so as to have a constant thickness in the radial direction as a whole, and each layer is also formed so as to have a constant thickness in the radial direction. An extruding speed of the extruder 110 is adjustable to any speed.

While sequentially moving each of a plurality of split molds 123, 124 in the direction in which the primary material 30a is extruded, the corrugation molding machine 120 brings the primary material 30a into close contact with an inner face formed by the plurality of split molds 123, 124 to form the secondary material 30b that corresponds to the filler tube 30 having an outer face corresponding to the inner face.

The corrugation molding machine 120 is used for a portion at which the shape of the primary material 30a formed through extrusion molding by the extruder 110 is changed. In the present embodiment, the corrugation molding machine 120 is mainly used for forming the bellows portion 33b and forming the second end portion 32. The corrugation molding machine 120 is used for changing the outer diameter of the primary material 30a also in a portion having a cylindrical shape.

The corrugation molding machine 120 includes a guide table 121, a suctioning device 122, a plurality of the split molds 123, 124, and a drive gear 125. An ellipsoidal first guide groove 121a and a second guide groove 121b which has the same shape as the first guide groove 121a and which is disposed adjacent to the first guide groove 121a are formed in the upper face of the guide table 121. Furthermore, communication holes 121c that communicate with the first guide groove 121a and the second guide groove 121b are formed in the guide table 121, as shown in FIG. 7. As shown in FIG. 7, the suctioning device 122 is connected to the communication holes 121c in the guide table 121, and suctions air in a space communicating with the communication holes 121c.

A plurality of first split molds 123 are molds for shaping one of two portions into which the filler tube 30 is divided along the axial direction. The plurality of first split molds 123 are sequentially moved on and along the first guide groove 121a of the guide table 121. That is, each of the plurality of first split molds 123 is sequentially moved to form a half part of the filler tube 30. Each of the plurality of first split molds 123 has a rack gear on the upper face.

A plurality of second split molds 124 are molds for shaping the other of the two portions into which the filler tube 30 is divided along the axial direction. The plurality of second split molds 124 are sequentially moved on and along the second guide groove 121b of the guide table 121. That is, each of the plurality of second split molds 124 is sequentially moved to form a remaining half part of the filler tube 30. Each of the plurality of second split molds 124 has a rack gear on the upper face.

A portion of the first split molds 123 and a portion of the second split molds 124 each have a shaping surface corresponding to the bellows portion 33b. Another portion of the first split molds 123 and another portion of the second split molds 124 each have a shaping surface corresponding to the second end portion 32.

A discharge opening of a nozzle 111 of the extruder 110 is disposed at a position, on the extruder 110 side, of a pair of molds formed by combining the plurality of first split molds 123 and the plurality of second split molds 124 with each other. That is, the primary material 30a is suctioned onto the inner circumferential surfaces of the pair of molds 123, 124 located at the position and thus shaped.

The drive gear 125 is a pinion gear for moving the plurality of first split molds 123 and the plurality of second split molds 124. The drive gear 125 is disposed on the extruder 110 side of the pair of molds formed by combining the plurality of first split molds 123 and the plurality of second split molds 124 with each other. The drive gear 125 meshes with the first split molds 123 and the second split molds 124, and is driven to rotate, whereby the plurality of first split molds 123 and the plurality of second split molds 124 are sequentially moved.

Furthermore, moving speeds of the plurality of split molds 123, 124 are changed by changing a rotation speed of the drive gear 125. Increase of the moving speeds of the plurality of split molds 123, 124 causes the filler tube 30 to have a thickness reduced in the radial direction at portions corresponding to the split molds 123, 124 located near the nozzle 111 of the extruder 110. Meanwhile, reduction of the moving speeds of the plurality of split molds 123, 124 causes the filler tube 30 to have a thickness increased in the radial direction at portions corresponding to the split molds 123, 124 located near the nozzle 111 of the extruder 110.

For example, moving speeds of the split molds 123, 124 corresponding to the flange 32b are lower than moving speeds of the split molds 123, 124 corresponding to the tubular body 32a. Accordingly, the thickness of the flange 32b in the radial direction is made greater than the thickness of the tubular body 32a in the radial direction.

The secondary material 30b discharged from the corrugation molding machine 120 has a shape continuous in the axial direction. That is, the continuous secondary material 30b has such a shape that a plurality of the filler tubes 30 connect to each other. Therefore, the continuous secondary material 30b shaped by the corrugation molding machine 120 is cut, by the cutting machine 130, so as to have a predetermined length, thereby forming each filler tube 30.

(9. Action of Molding Second End Portion 32)

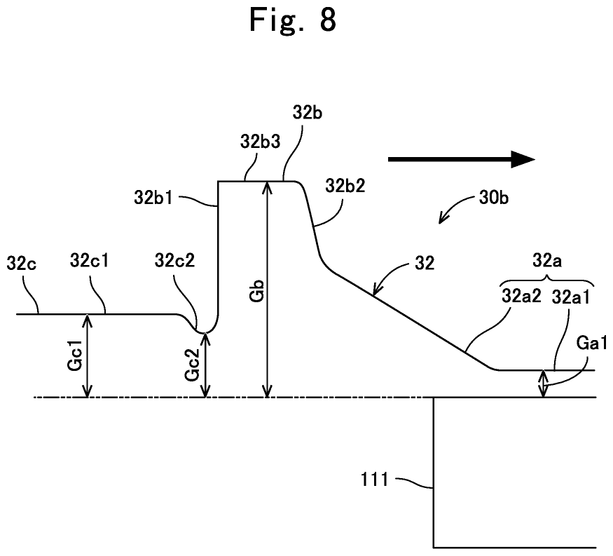

Next, the action of molding the second end portion 32 of the filler tube 30 (secondary material 30b) will be described with reference to FIG. 8. FIG. 8 shows a contour of the outer face of the second end portion 32 in the secondary material 30b. That is, the contour of the outer face of the second end portion 32 represents the inner circumferential surfaces of the plurality of the split molds 123, 124. The leading end of the nozzle 111 of the extruder 110 is also shown.

As indicated by an arrow in FIG. 8, the molded secondary material 30b (split molds 123, 124) moves rightward with respect to the nozzle 111 in FIG. 8. That is, the order in which the portions of the secondary material 30b are molded is the order of the first end portion 31 (shown in FIG. 2), the intermediate portion 33 (shown in FIG. 2), and the second end portion 32. The order in which the portions of the second end portion 32 are molded is the order of the tubular body 32a, the flange 32b, and the leading end tubular portion 32c.

Gaps between the radially outer end of the nozzle 111 and the outer face of the second end portion 32 in the secondary material 30b are as follows. A gap between the minimum outer diameter portion 32a1 of the tubular body 32a and the nozzle 111 is Ga1. A gap between the outer circumferential surface 32b3 of the flange 32b and the nozzle 111 is Gb. A minimum gap between the annular recessed groove 32c2 of the leading end tubular portion 32c and the nozzle 111 is Gc2. A gap between the maximum outer diameter portion 32c1 of the leading end tubular portion 32c and the nozzle 111 is Gc1.

In general, in a case where the gap between the portion and the nozzle 111 is continuously great, air is likely to enter, and a degree of vacuum tends to be reduced. In this case, the accuracy of the shape of the molded product is likely to be degraded.

The gap between the nozzle 111 and the outer circumferential surface 32b3 of the flange 32b is the largest of these gaps. That is, a gap is increased from the tubular body 32a toward the flange 32b. Therefore, the degree of vacuum is gradually reduced. The leading end tubular portion 32c is molded in a state where the degree of vacuum has been reduced at the flange 32b. Therefore, whether or not the accuracy of the shape of the leading end tubular portion 32c is made high needs to be considered.

However, the annular recessed groove 32c2 is located immediately following the flange 32b. The gap Gc2 for the annular recessed groove 32c2 is less than the gap Gc1 for the maximum outer diameter portion 32c1 of the leading end tubular portion 32c. Accordingly, after the degree of vacuum is reduced at the flange 32b portion, the gap Gc2 for the annular recessed groove 32c2 is reduced. Therefore, the degree of vacuum is inhibited from being continuously low.

The degree of vacuum is made sufficiently high at the annular recessed groove 32c2. Thus, the degree of vacuum is not made continuously low in the subsequent molding of the maximum outer diameter portion 32c1 of the leading end tubular portion 32c. Accordingly, the accuracy of molding the leading end tubular portion 32c is made high.

What is claimed is:

1. A resin filler tube to be welded to an outer circumferential edge of an opening hole of a fuel tank, the resin filler tube comprising:
a tubular body having an outermost layer formed by using an outermost layer material, and one or more inner layers each formed by using an inner layer material;
a flange configured to protrude radially outward from an end of the tubular body on the fuel tank side, over an entire circumference, the flange having a plurality of layers that are of same kinds as those of the tubular body, the flange having outer faces all of which are formed of the outermost layer material, the flange having a first end face in an axial direction, the first end face forming a weld surface to be welded to the outer circumferential edge of the opening hole of the fuel tank; and
a leading end tubular portion extending from a radially inner portion of the flange toward a leading end of the resin filler tube, the leading end tubular portion having an annular recessed groove formed at a portion of an outer circumferential surface on the flange side, over an entire circumference, the annular recessed groove storing a melt burr generated in welding of the first end face.

2. The resin filler tube according to claim 1, wherein
the tubular body has a minimum outer diameter portion having a predetermined smallest outer diameter,
a maximum outer diameter of the leading end tubular portion is greater than the outer diameter of the minimum outer diameter portion of the tubular body, and
a minimum outer diameter of the annular recessed groove of the leading end tubular portion is equal to or greater than the outer diameter of the minimum outer diameter portion of the tubular body, and is less than the maximum outer diameter of the leading end tubular portion.

3. The resin filler tube according to claim 1, wherein the annular recessed groove has a surface continuous with the first end face of the flange without forming a stepped portion between the annular recessed groove and the first end face of the flange.

4. The resin filler tube according to claim 1, wherein the annular recessed groove is formed so as to have a groove width that is less than a thickness of an inner circumferential surface of the opening hole of the fuel tank.

5. The resin filler tube according to claim 1, wherein the leading end tubular portion is formed so as to have an outer diameter that is less than an inner diameter of the inner circumferential surface of the opening hole of the fuel tank, over an entire length.

6. The resin filler tube according to claim 1, wherein a melt portion of the first end face melted by welding is formed of the outermost layer material only.

7. A manufacturing method for manufacturing the resin filler tube according to claim 1, the manufacturing method comprising:
extruding a tubular material having a plurality of layers by an extruder; and
forming the resin filler tube by bringing the tubular material into close contact with an inner face formed by a plurality of split molds while sequentially moving the plurality of split molds in a direction in which the tubular material is extruded, such that the resin filler tube has an outer face corresponding to the inner face.
